(19) United States
(12) Patent Application Publication
(10) Pub. No.: US 2022/0036370 A1
(43) Pub. Date: Feb. 3, 2022

(54) DYNAMICALLY-GUIDED PROBLEM RESOLUTION USING MACHINE LEARNING

(71) Applicant: EMC IP Holding Company LLC, Hopkinton, MA (US)

(72) Inventors: Carlos Felipe Rodman, Round Rock, TX (US); Mohammed Athaulla, Bangalore (IN); Yogish KS, Bangalore (IN); Rohan S. Kulkarni, Bangalore (IN); Senthil T. Kumar, Bangalore (IN); Sukanya Mitra, Bangalore (IN); Sathya Padmanabhan, Bangalore (IN); Afzal Pasha, Bangalore (IN); Badarinath Raghavendra, Bangalore (IN); Janardhan S R, Bangalore (IN); Pradeep Sekaran, Bangalore (IN); Nissar Ahmed Abdul Rahim, Bangalore (IN); David Thomas Kirkpatrick, Cedar Park, TX (US); Somenath Samanta, Bangalore (IN); Shalu Singh, Round Rock, TX (US); Mohammed Amin, Austin, TX (US); Karthik Ranganathan, Round Rock, TX (US); Raghav Sarathy, Austin, TX (US); Amit Sawhney, Round Rock, TX (US)

(21) Appl. No.: 16/944,860

(22) Filed: Jul. 31, 2020

(51) Int. Cl. G06Q 30/00; G06N 20/00; G06Q 30/06

(52) U.S. Cl. CPC G06Q 30/016; G06Q 30/0627; G06N 20/00

(57) ABSTRACT

Methods and systems are disclosed that include the identification of one or more actions in an action flow that is intended to resolve a problem, and to guide a user through the one or more actions of such an action flow, dynamically adjusting the action flow during such guidance and/or subsequent thereto, using machine learning techniques. In some embodiments, such a method can include. for example, receiving outcome information at a machine learning system (where the outcome information is associated with an action of an action flow and the action flow comprises a plurality of actions), generating update information (where the update information is generated by the machine learning system based, at least in part, on the outcome information), and updating action information of the action (where the action information is updated based, at least in part, on the update information).

### BACKGROUND

### Technical Field

This invention relates generally to problem resolution and, more particularly to the dynamic identification of one or more actions intended to resolve a problem through the use of machine learning techniques.

Description of Related Technologies

As the value and use of information continues to increase, individuals and businesses seek additional ways to process and store information. One option available to users is information handling systems (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Such information handling systems have readily found application in a variety of applications, including customer service applications (e.g., in the context of customer support environments such as call centers). Information handling systems employed in such customer service applications are able to provide large amounts of information to customer service representatives tasked with assisting customers in resolving problems encountered by such customers. For example, such customer service applications can allow customer service representatives to access all manner of information regarding a product with which a customer might be encountering a problem. Unfortunately, such a deluge of information also represents an obstacle to the provision of effective, efficient assistance to such customers. Further, such an approach relies heavily on the knowledge, experience, and judgment of the customer service representative, leading to inconsistent performance with regard to the resolution of customers' problems. Further still, such reliance, coupled with the large amounts of information provided by such systems, leads to an increase in the likelihood of unsuccessful resolutions. Moreover, traditional approaches to providing customers and/or customer service representatives with guidance have proven inflexible and inefficient.

### SUMMARY

This Summary provides a simplified form of concepts that are further described below in the Detailed Description. This Summary is not intended to identify key or essential features and should therefore not be used for determining or limiting the scope of the claimed subject matter.

Methods and systems such as those described herein provide for the identification of one or more actions in an action flow that is intended to resolve a problem, and to guide a user through the one or more actions of such an action flow, dynamically adjusting the action flow during such guidance and/or subsequent thereto, using machine learning techniques. In some embodiments, such a method can include. for example, receiving outcome information at a machine learning system (where the outcome information is associated with an action of an action flow and the action flow comprises a plurality of actions), generating update information (where the update information is generated by the machine learning system based, at least in part, on the outcome information), and updating action information of the action (where the action information is updated based, at least in part, on the update information).

The foregoing is a summary and thus contains, by necessity, simplifications, generalizations, and omissions of detail; consequently those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a simplified block diagram illustrating an example of a dynamic resolution architecture, according to some embodiments.

FIG. 2 is a simplified block diagram illustrating an example of a dynamic resolution architecture, according to some embodiments.

FIGS. 3A and 3B are simplified block diagrams illustrating an example of a dynamic resolution architecture, according to some embodiments.

FIG. 4 is a simplified block diagram illustrating an example of an action flow, according to some embodiments.

FIG. 5 is a simplified block diagram illustrating an example of a dynamic resolution architecture, according to some embodiments.

FIG. 6 is a simplified block diagram illustrating an example of a cloud-based dynamic resolution architecture, according to some embodiments.

FIG. 7 is a simplified flow diagram illustrating an example of a problem resolution process, according to some embodiments.

FIG. 8 is a simplified flow diagram illustrating an example of a dynamic resolution process, according to some embodiments.

FIG. 9 is a simplified flow diagram illustrating an example of a previous action update process, according to some embodiments.

FIG. 10 is a simplified flow diagram illustrating an example of a subsequent action update process, according to some embodiments.

FIG. 11 illustrates an example configuration of a computing device that can be used to implement the systems and techniques described herein.

FIG. 12 illustrates an example configuration of a network architecture in which the systems and techniques described herein can be implemented.

### DETAILED DESCRIPTION

Overview

Methods and systems such as those described herein can be implemented, for example, as a method, network device, and/or computer program product, and provide for the identification of one or more actions to resolve a problem, and improving the performance of such systems by dynamically modifying such systems' action paths, using machine learning (ML) techniques. For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

As noted, certain embodiments of methods and systems such as those disclosed herein can include operations such as receiving outcome information at a machine learning system, generating update information, and updating action information of the action. The outcome information is associated with an action of an action flow, and the update information is generated by the machine learning system based, at least in part, on the outcome information. The action information is updated based, at least in part, on the update information.

In such systems, information regarding the one or more issues at hand (e.g., problem information) can be received from a user interface at an issue identification system, as can information regarding the systems in question (e.g., product information). Machine learning analysis of and the application of business rules to the problem information and the product information can be performed, as a part of presenting such information to a dynamic resolution system. In certain embodiments, the aforementioned problem information can describe one or more characteristics of a problem, while the aforementioned product information can describe one or more characteristics of a product.

In one embodiment, such a method can include identifying one or more actions of a plurality of actions and generating the action flow. Other embodiments can include performing an outcome analysis, wherein the outcome analysis is based, at least in part, on information produced by executing the action, the machine learning analysis is performed by one or more machine learning systems of the resolution identification system, and a result of the outcome analysis is fed back to the machine learning system. Such embodiments can also include updating other action information of another action of the plurality of actions, where the other action information is updated based, at least in part, on the result of the outcome analysis. Such embodiments can also include applying a business rule to the result of the outcome analysis, prior to the updating the action information of the action.

In another embodiment, such a method can include receiving product information at a dynamic resolution system (where the product information describes one or more characteristics of a product) and receiving problem information at the dynamic resolution system (where the problem information describes one or more characteristics of a problem encountered with the product. Such embodiments can also include performing machine learning analysis of the problem information and the product information, where the machine learning analysis produces one or more outputs, the machine learning analysis is performed by the machine learning system, and the machine learning analysis is performed using one or more machine learning models. The one or more machine learning models comprise at least one of a guided path model, a soft model, a hard model, or a cluster model. Such problem information can include, for example, error information regarding an error experienced in operation of the product or symptom information regarding a symptom exhibited by the product in the operation of the product. Further, such embodiments can also include retrieving one or more system attributes for a product identified by the product information and retrieving a support history for the product.

### Introduction

As noted, methods and systems such as those described herein provide for the identification of a course of action to resolve a problem through the use of machine learning techniques. Such methods and systems include the use of machine learning techniques to analyze available information, and, in certain embodiments, can do so using minimal inputs (e.g., in the case of providing customer support for a computing device, identifying information that uniquely identifies the particular computing device and a description of the problem encountered). More specifically, methods and systems such as those described herein provide for the identification of one or more actions in an action flow that is intended to resolve a problem, and to guide a user through the one or more actions of such an action flow, dynamically adjusting the action flow during such guidance and/or subsequent thereto, using machine learning techniques.

As will be appreciated, the simplistic approaches to resolving problems with a given product employed heretofore (e.g., in the customer support context) leave a great deal to be desired. One example of such situations is a customer contacting a customer service representative (e.g., at a call center) with regard to a problem encountered in the operation (the functioning, or lack thereof, of the product itself) or use of the product by a customer. While call center information systems are able to provide large amounts of information to customer service representatives tasked with assisting customers in resolving problems encountered by such customers, such a flood of information can itself present an obstacle to assisting the customer. Further, such an approach relies heavily on the knowledge, experience, and judgment of the customer service representative, leading to inconsistent performance with regard to the resolution of customers' problems. Further still, such reliance, coupled with the large amounts of information provided by such systems, leads to an increase in the likelihood of unsuccessful resolutions. The accuracy with which the customer relates information regarding the problem can also affect the likelihood of successful problem resolution. Thus, as will be appreciated, such troubleshooting efforts represent a complex process, where symptom interpretation depends heavily on the communication skills of the customer and customer service agent. While a customer service agent can attempt to effect clear communications, the issue identification performed often relies upon open-ended questions and manual information searches by the customer service agent.

Moreover, existing call center information systems have no capabilities that might help customer service representatives compensate for such inadequacies and address such systemic shortcomings (e.g., as by standardizing the interactions of such customer service representatives and customers with such systems, by learning from existing information, and by adapting to new situations presented in such contexts). Further still, such existing call center information systems can fail to provide for the consideration of known issues that might impact issues encountered by end-users. As will therefore be appreciated, such interactions tend to be long and wide-ranging, and so are inefficient in terms of the time and resources involved, not to mention deleterious to the customer experience.

A problem of particular concern is that hundreds of factor combinations can be produced by various combinations of symptoms, customer types, system types, environmental factors, and other such considerations can not only impact the success rates of the various troubleshooting methods, but lead to a combinatorial explosion of potential combinations. As will be appreciated, sustaining a static model that attends to account for so many outcomes is impractical. Moreover, it is also not possible for trained support representatives to consistently account for them.

Such problems can be addressed through the use of dynamic resolution approaches that employ methods and systems such as those described herein. Such dynamic problem resolution techniques address these issues by bringing to bear machine learning techniques that are designed to consume certain types of information (e.g., such as product information and problem information) and, from such information types, produce and/or update an action flow that includes one or more recommended actions intended to resolve the problem presented. By implementing machine learning techniques specifically applicable to the context of assisting a given user of a given product in the resolution of problems encountered in such product's use, such methods and systems avoid the problems associated with, for example, the need for customer service representatives to sift through large amounts of information, and so avoid the complications such approaches engender. In so doing, such systems address problems related to inconsistent outcomes caused by a lack of experience and/or poor judgement of customer service representatives.

Moreover, an additional advantage provided by such systems is the more efficient (and so quicker) resolution of problems as the system in question is used. In fact, methods and systems such as those described herein can, in certain situations, provide increasingly improved outcomes, as such systems accumulate more and more experience. In this regard, methods and systems such as those described herein are able to learn the manner in which a product's users describe various problems they encounter, and in so doing, are able to more accurately characterize such problems. Such increases in accuracy facilitate a more efficient use of resources, particularly in the context of computing resources (which becomes even more meaningful when such methods and systems are employed in a self-service context).

To achieve such advantages, methods and systems such as those described herein provide for a support organization to continually take advantage of benefits that emerge based on a multitude of system and symptom scenarios through machine learning, particularly when compared to manual decision tree manipulation. Methods and systems such as those described herein, in certain embodiments, build a product profile (system serviceability matrix) and context based on attributes that can include, for example:
Diagnostic capability
Component accessibility
Product configuration (SA)
As-Maintained software (SA)

Machine learning analysis can then be performed on the data thus prepared, in order to produce an action flow that includes the one or more actions intended to address the problem at hand. In a computing device scenario, recommended actions can include “soft” fixes (in which the given problem can be fixed remotely by performing particular actions (e.g., a hard reset) or using software (e.g., installing update drivers)), “hard” fixes (in which a service dispatch, including parts, labor, or both, is needed), or, in the case of more complicated problems, the implementation of a guided path process (in which a guided path is followed to troubleshoot the given computing device and gather additional information). In view of this, the examples provided subsequently describe three machine learning models, one corresponding to each of the foregoing scenarios, which can be invoked. Also described is a cluster model that takes as its input one or more keywords, and determines clustering of problems and the resolutions using such inputs.

A method to modularize the dynamic steps in the troubleshooting process and apply symptom and serviceability attributes to each of the types,
Probing
Diagnostics
Troubleshooting
Solutions

In one embodiment, the symptom reported by, for example, a customer (case classification), data points such as those described above, customer persona/intent, and other such information can be aggregated, and the historical support context applied. In so doing, the next best step can be suggested, along with the ability to continually refresh the module/step selection thru supervised learning.

Methods and systems such as those described herein are able to suggest proper automation-flow and record success rates at the module/step (action) level. Additional experimentation and modeling can be performed to identify a broader set of possible scenarios that impact success. These factors can then be added to the conditional logic, business rules, and machine learning systems to take further advantage of the findings.

Thus, a dynamic resolution architecture according to the methods and systems described herein provides a number of advantages. These include the ability of such an architecture to adapt its functionality and behavior to changes in the operational environment (e.g., as to the level of success enjoyed by one or more of the actions taken to resolve the problem in question, new products, new problems, and other sources of variability in the scenarios encountered), and in so doing, to facilitate self-adaptability in response to such changes by way of feedback and the availability of new product information, additional historical information, and the like (it being appreciated that historical information employed by methods and systems such as those described herein can be specific to a given asset (a specific instance of the given product) or more broadly, to a given group of assets, product model, product brand, and other such aggregations). In certain embodiments, such methods and systems are able to learn from user feedback provided during the customer support experience and other such outcome information, and revise predictions and recommendations made in “real time” (e.g., in under 30 seconds, in a call center context), as may be suggested by the data and machine learning models. Further, such methods and systems provide for the efficient, effective implementation of problem resolution alternatives through such methods and systems use of machine learning, thereby providing action recommendations with acceptably-high confidence (as by the prediction of the next best action to be taken). Further still, such methods and systems support the visualization of one or more outputs (one or more potential resolutions) of the machine learning models employed, as well as the level of confidence that can be attributed to such potential resolutions. Further still, such methods and systems are able to take into account business imperatives by way of the generation and maintenance of business rules. These and other advantages will be apparent in view of the following description and associated figures.

### Example Overall Dynamic Resolution Process Employing Machine Learning

A simplified dynamic resolution process, according to some embodiments, is described herein. The basic steps performed in such a dynamic resolution process include the gathering of information (e.g., symptoms, information regarding failures, and the like), the interpretation of this information (also referred to herein as symptom interpretation), the identification of issues (also referred to herein as issue identification), and one or more actions to be taken in an effort to resolve the problems giving rise to the need for resolving the issue. The process can begin with the receipt of information regarding the systems in question (e.g., product information (e.g., such as a serial number, service tag information, or other such information regarding a product)) at a dynamic resolution system (e.g., such as that described subsequently herein). In the case of a product, such information can also include technical support information for the product, repair service information for the particular item, field service information for the product and/or particular item, online service information for the product and/or the particular item, telemetry data from the particular item, social media data, and/or routing and voice data, among other such types of information. The dynamic resolution system can also receives information regarding a problem (also referred to herein as problem information). As with the aforementioned product information, such problem information can include the aforementioned information types, among other such types of information, for the problem encountered (e.g., including one or more error codes and/or symptom information). It will be further appreciated that such a problem may represent a failure in the given product, faulty operation of the given product (thereby permitting one or more symptoms of such faulty operation to be gathered), simply a question as to the proper operation of the given product, and other such inquiries, as might be addressed to customer support representatives in a customer support environment. Further still, such product information and problem information can be used to generate and/or retrieve additional contextual information automatically. For example, a product's identifying information (e.g., serial number, service tag, or the like) can be used to determine the product's brand, model, age, and other such information, as well as historical information regarding the product's service history, other attempts to address the problem at hand, and other such information. Sources of such information can include diagnostic logs for the product, a case title and/or description, agent logs/chat transcripts/contact history from prior contacts from the customer, service department dispatch history, web history, Interactive Voice Response (IVR)/telephony transcripts, and/or other such information.

In the case in which the product information includes identifying information such as a serial number, service tag information, or comparable information identifying, for example, a computing device, such identifying information can be used to retrieve/analyze existing information regarding the product in question (e.g., such as system attributes and support history for a computing device). Such retrieved information can include, for example, component information, product specifications, repair history, information regarding earlier customer inquiries regarding the given product and/or related/independent problems (as well as transcripts regarding same), and the like. In this regard, the resolution identification system works to aggregate information that may itself prove useful in determining one or more actions to be taken to resolve the given problem, as well as providing an avenue to other information, be that additional customer support information and/or trends that might be deduced from such information using the machine learning model(s) employed.

Having received the product information and the problem information (and, optionally, the aforementioned existing information), the dynamic resolution process can proceed with performing one or more machine learning analyses using such product information and problem information (and, optionally, existing information and/or other information). Using the various system inputs, as well as analysis thereof by machine learning systems and, optionally, business rule processing systems, actions of an action flow can be identified, selected, and updated as necessary. The action(s) to be taken as part of the action flow (also referred to herein, in the generic, as the “next best action” in the action flow) can be performed, for example, in a step-wise fashion. In so doing, machine learning analyses provide for the correlation between inputs, context, and a particular outcome, as well as for the correlation of historical inputs (e.g., for confidence scoring), thereby providing the ability to predict outcomes for current inputs and given context, and to facilitate the dynamic nature of action flows generated and/or updated according to embodiments such as those described herein. Such machine learning analyses (and the machine learning models such analyses employ), as well as various means of combining they are machine learning outputs, provide a flexible and efficient approach to problem resolution, and are discussed in greater detail subsequently.

Further, outcome analysis (also referred to herein as “resolution analysis”) can be performed, and can include any number of techniques, including, but not limited to, receipt of user feedback, statistical analyses, receipt of results (e.g., as by querying a computing device, telemetry reports from the computing device, and or other such methods), and/or the like. The results of such resolution analysis can then be fed back into the machine learning systems, as well as certain of the product information sources and machine learning inputs.

### Example Dynamic Resolution Architectures Employing Machine Learning

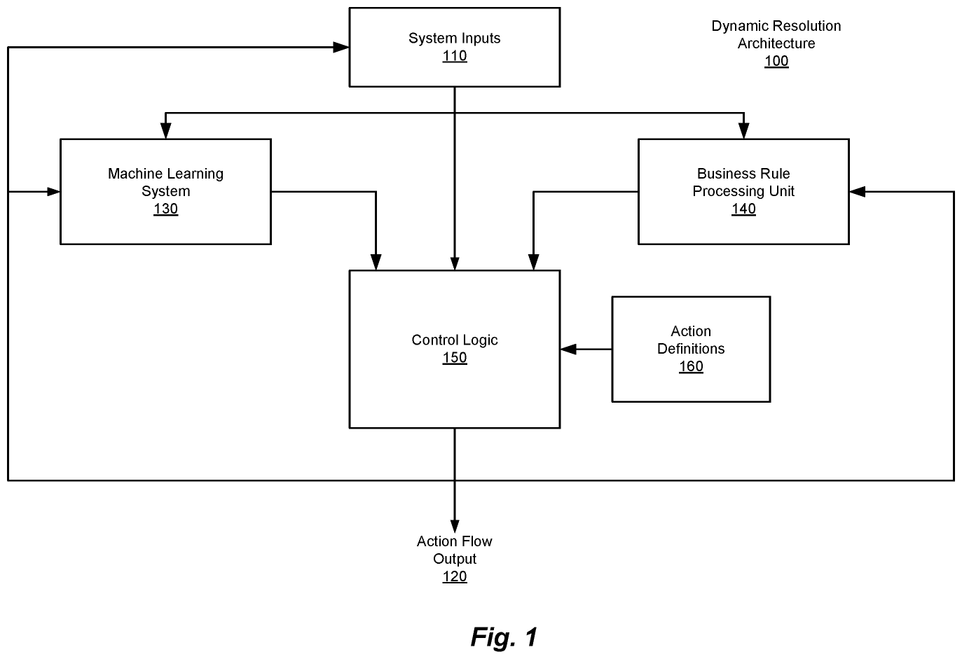

FIG. 1 is a simplified block diagram illustrating an example of a dynamic resolution architecture, according to some embodiments. FIG. 1 thus illustrates a dynamic resolution architecture 100. Dynamic resolution architecture 100 receives one or more inputs (depicted in FIG. 1 as system inputs 110), and produces guidance for a user to follow in order to address the given situation (e.g., resolve a problem at hand, and depicted in FIG. 1 as an action flow output 120). System inputs 110 can include information from one or more sources, as well as one or more results of a previous action taken. System inputs 110 are provided to a machine learning system 130, a business rule processing unit 140, and control logic 150. Control logic 150 also accesses one or more action definitions, from which actions appropriate to the given action flow implemented by control logic 150 can be identified, selected, and used to generate the action flow in question. Such action definitions are depicted as action definitions 160.

Action flow output 120 can be presented to a user as, for example, as a next action to be performed in order to address the situation at hand, in which case, the action flow in question can be maintained in control logic 150. In so doing, action information regarding the actions of the action flow can be updated as a user proceeds through the action flow in question (on an action-by-action basis), upon completion of the action flow in question (and so update the requisite actions of the action flow at once), or a combination thereof. Alternatively, the action flow represented by action flow output 120 can be provided to a user in whole or in part, through which the user can proceed to the action flow's completion, updating the action flow in question upon such completion.

In supporting the dynamic updating of action information for actions in an action flow, a dynamic resolution systems such as that depicted as dynamic resolution architecture 100 is able to employ the machine learning techniques provided by machine learning system 130 in order to update such action information during the provision of such guidance to a user and/or subsequent thereto. Further, business rules implemented by business rule processing unit 140 can serve to guide and/or constrain the action flow in question. In order to do so, one or more outputs of machine learning system 130 and business rules processing unit 140 are supplied to control logic 150, which uses such inputs in order to identify and select actions from action definitions 160 to create and/or update an action flow intended to address the situation at hand.

In so doing, dynamic resolution architecture 100 is able to provide intelligence to the action flow authoring platform of dynamic resolution architecture 100. Such a flexible and efficient approach to authoring platform intelligence is particularly advantageous in scenarios in which complex, multiple-action action flows are needed. Basic action flows can be created by a user, or can be generated automatically, based on characteristics of the situation at hand and actions maintained in action definitions 160 that are applicable to such situations. In providing such a dynamic approach, updates to action information can effect not only varying action flows, but also varying paths through such action flows (e.g., allowing one or more such actions to be skipped, in a given scenario). Further still, a user can be provided the ability to approve or reject a given proposed action flow, as well as resequence or eliminate one or more actions of the given action flow.

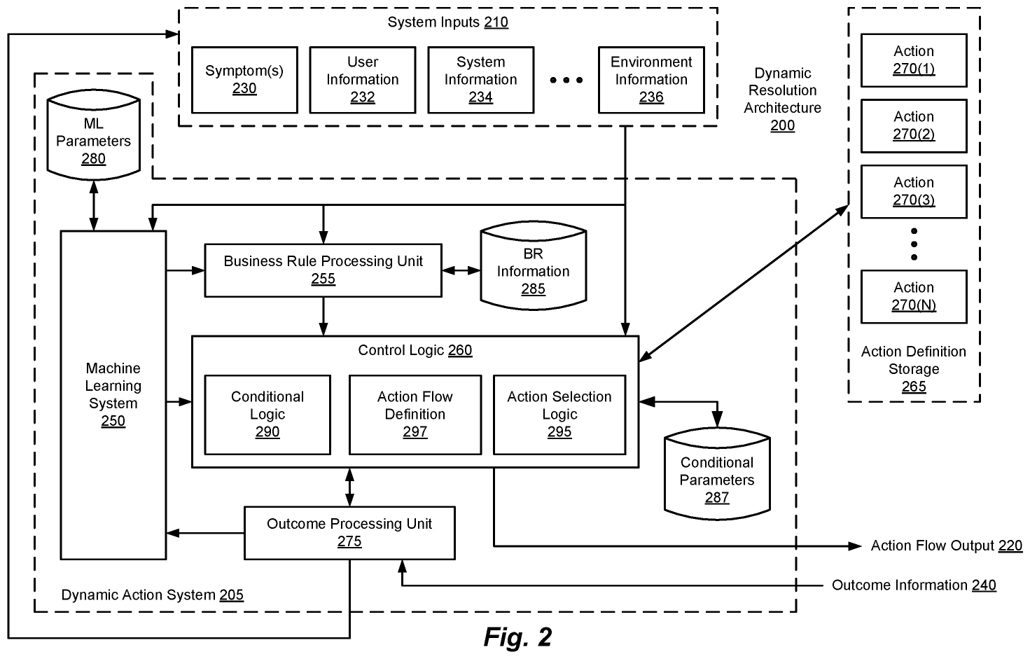

FIG. 2 is a simplified block diagram illustrating an example of a dynamic resolution architecture, according to some embodiments. FIG. 2 thus illustrates a dynamic resolution architecture 200. In the manner of dynamic resolution architecture 100, dynamic resolution architecture 200 includes a dynamic action system 205 that receives one or more inputs (depicted in FIG. 2 as system inputs 210) and produces an action flow output (depicted in FIG. 2 as an action flow output 220, in the manner of action flow output 120 of FIG. 1). System inputs 210 can include one or more symptoms 230 (e.g., as might be experienced by, for example, a computer system), information regarding a user of such a system (depicted in FIG. 2 as user information 232), information regarding a system experiencing the issue (depicted in FIG. 2 as system information 234), information regarding the environment in which the system is being used (depicted in FIG. 2 as environment information 236), among other such possible system inputs. System inputs 210 can also include outcome information 240, which is input to dynamic action system 205 and can be passed into dynamic action system 205 as one of system inputs 210, either with or without processing.

The information received as system inputs 210 by dynamic action system 205 is provided to various components within dynamic action system 205, which can include a machine learning system 250, a business rule processing unit 255 and control logic 260. In addition to receiving one or more of system inputs 210, and the outputs of machine learning system 250 and business rule processing unit 255, control logic 260 is also able to access action definitions storage 265 and the action definitions stored therein (depicted in FIG. 2 as actions 270(1)-(N)).

In providing update information to control logic 260, machine learning system 250 can receive outcome information 240 and/or the results of outcome processing of outcome information 240 by an outcome processing unit 275. Machine learning system 250 is also able to maintain machine learning parameters (depicted in FIG. 2 as machine learning parameters 280), which can include parameters such as the weights and biases employed in certain machine learning techniques, function definitions, and other such machine learning parameters.

In a similar fashion, business rule processing unit 255 can receive one or more of system inputs 210, one or more outputs of machine learning system 250, and/or outcome information 240 (whether in its original form or after outcome processing by outcome processing unit 275; not shown in FIG. 2 for the sake of simplicity). Business rule processing unit 255 maintains business rules and other related information in business rules information 285.

Similarly, control logic 260 maintains one or more conditional parameters as conditional parameters 287. Conditional parameters 287 can include information regarding which actions of actions 270 are applicable in a given situation, the possible ordering of those actions, next action probabilities (e.g., the probability of an action following a given action), and other such action flow characteristics. Control logic 260, in the embodiment depicted in FIG. 2, includes conditional logic 290 and action selection logic 295. In the manner noted, action selection logic 295 identifies and selects one or more actions of actions 270 to be included in the action flow in question. Conditional logic 290 uses the information in conditional parameters 287 to construct and/or update the relationships between the actions of the action flow.

Through the operations effected by action selection logic 295 and conditional logic 290, and action flow definition 297 can be created and/or updated. As will be appreciated, in one scenario, an author can manually create an action flow such as that which might be defined by action flow definition 297, or control logic 260 and its various functionalities can be used to generate such an action flow.

It will be appreciated that, in light of the present disclosure, the variable identifier “N” is used in several instances in various of the figures herein to more simply designate the final element of a series of related or similar elements. The repeated use of such variable identifiers is not meant to imply a correlation between the number of elements in such series. The use of variable identifiers of this sort in no way is intended to (and does not) require that each series of elements have the same number of elements as another series delimited by the same variable identifier. Rather, in each instance of use, variables thus identified may represent the same or a different value than other instances of the same variable identifier.

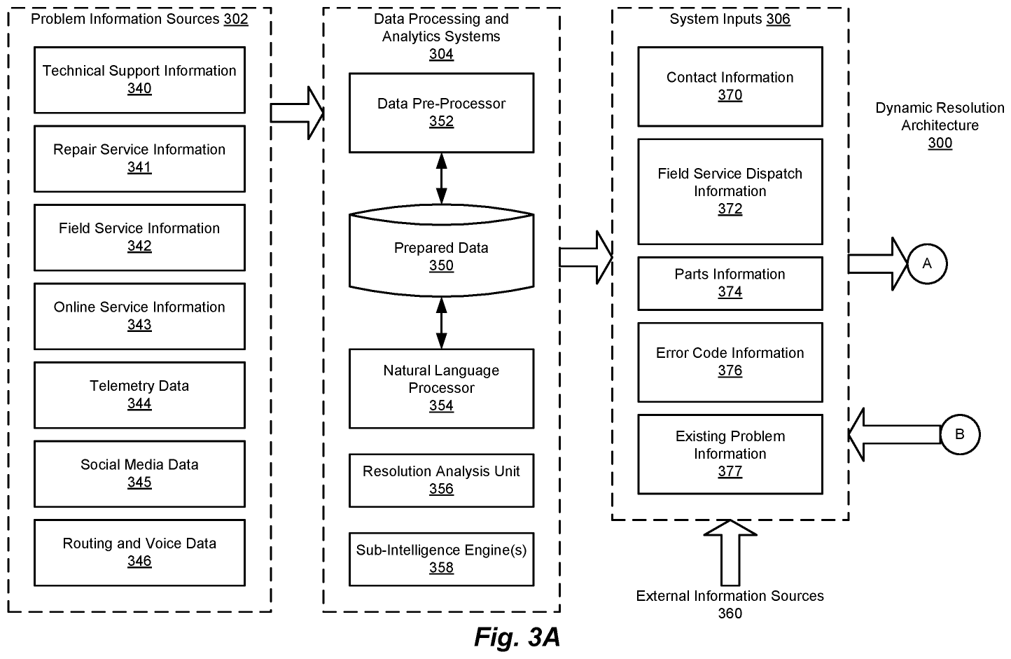

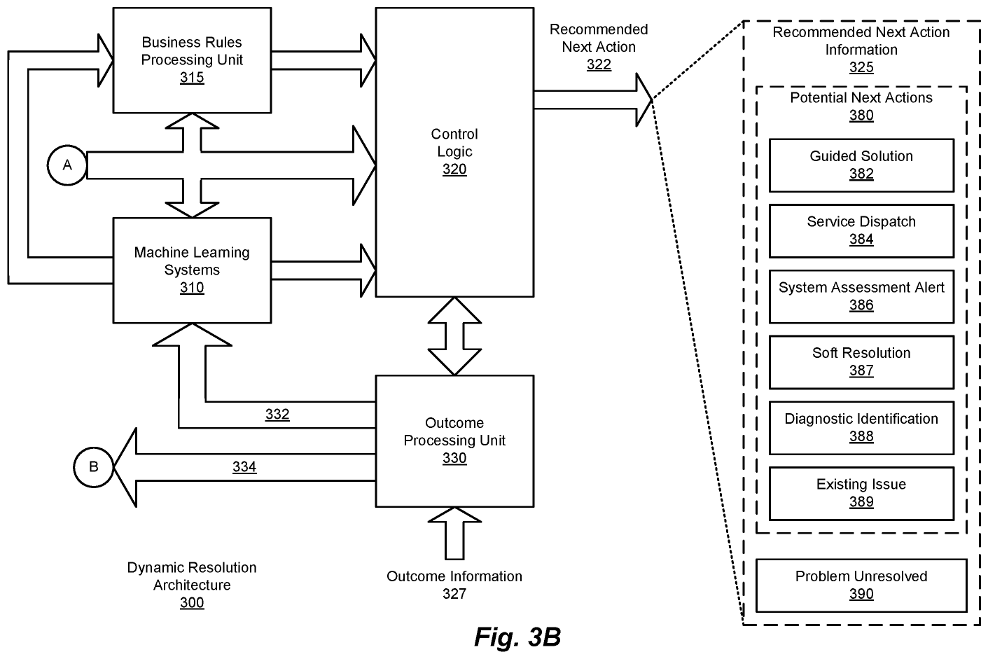

FIGS. 3A and 3B are simplified block diagrams illustrating an example of a resolution determination architecture that can be employed to implement a resolution determination process such as that supported by the architectures of FIGS. 1 and 2, according to some embodiments. To that end, FIGS. 3A and 3B depict a dynamic resolution architecture 300, which includes problem information sources 302, data processing and analytics systems 304, and system inputs 306. Problem information sources 302 provide various types of information (discussed subsequently) to data processing and analytics systems 304 (also discussed subsequently), which perform processing and analysis of such information to produce certain of system inputs 306 (discussed subsequently as well).

In turn, system inputs 306 are provided to one or more machine learning systems (depicted in FIG. 3B as machine learning systems 310) and a business rules processing unit (depicted in FIG. 3B as business rules processing unit 315), as well as control logic (depicted in FIG. 3B as control logic 320), by way of connector “A”. Machine learning systems 310 and business rules processing unit 315, as well as system inputs 306, are provided to control logic 320 in order to produce a recommended next action 322, which can be described by recommended next action information 325. Recommended next action information 325 and, optionally, outcome information 327, are provided to an outcome processing unit 330. Outcome processing unit 330 analyzes information regarding the effects of recommended next action 322, generating feedback therefrom. The feedback generated is provided to machine learning systems 310 as feedback 332, and to certain of the information sources of system inputs 306, as feedback 334.

As noted, problem information sources 302 provide information to the processes performed by data processing and analytics systems 304. Problem information sources 302 represents a number of information sources, which can include, for example, one or more of the following: technical support information 340, repair service information 341, field service information 342 (e.g., as might be received from field service personnel), online service information 343, telemetry data 344, social media information 345, and routing invoice information 346, among other such sources of information.

Data processing and analytics systems 304 take as their input information sourced from problem information sources 302, as noted. In the embodiment shown in FIG. 3A as part of dynamic resolution architecture 300, data processing and analytics systems 304 receive information from problem information sources 302 and store this information as incoming data (depicted in FIG. 3A as prepared data 350). Typically, information received from problem information sources 302 is received by data processing and analytics systems 304 at, for example, a data preprocessor 352. Data preprocessor 352, in certain embodiments, performs operations such as data preprocessing and data cleansing, in order to prepare information received from problem information sources 302 for natural language processing and other such operations. The data preprocessing and data cleansing performed by data preprocessor 352 can include operations such as stop word removal, tokenization of the problem information (e.g., using lexical analysis), stemming of words in the problem information (e.g., where such stemming performs a process of reducing inflected (or sometimes derived) words to their word stem, base, or root form), and term frequency-inverse document frequency (TFIDF) analysis. In the present context, such TFIDF techniques employ a numerical statistic that is intended to reflect how important a word is to a document in a collection or corpus. It is often used as a weighting factor in searches of information retrieval, text mining, and user modeling. A TFIDF value increases proportionally to the number of times a word appears in the document and is offset by the number of documents in the corpus that contain the word, which helps to adjust for the fact that some words appear more frequently in general.

In certain embodiments, data preprocessor 352 performs preprocessing operations on the information received from problem information sources 302 and then stores this preprocessed data as prepared data 350. Natural language processing can then be performed on repair data 350 by a natural language processor 354. Natural language processor 354 can employ one or more of a number of natural language processing techniques to process the prepared data into a better form for use as one or more of system inputs 306. Such techniques can include, for example, keyword extraction, relationship extraction (e.g., the extraction of semantic relationships between words and/or phrases from prepared data 350), part-of-each tagging, concept tagging, summarization, and sentiment analysis classification, among other such techniques applicable to information received as problem information and preprocessed by data preprocessor 352. Thus, the preprocessing of problem information need not employ a predefined list of keywords. Rather, keywords can be extracted dynamically from the problem information received. For example, natural language processing can be applied in order to remove common words and numbers (e.g., “the”, “on”, “and”, “42”, and so on), remove words that do not add value to a problem description (e.g., “not working”, “issues”, and so on), remove words that are common in past tech support logs but not indicative of the problem (e.g., operating system, operating system version, and so on), removing words specific to the asset that can be obtained more efficiently otherwise (e.g., warranty information, brand information, and so on), replacing common abbreviations with standard descriptions (in order to provide for more consistent input to the machine learning systems; e.g., replacing “HDD” with “hard drive” and so on), and other such operations. The text which remains can be treated as the extracted keywords. Such a dynamic processing approach facilitates the machine learning systems' adaptability, and so, the ability to handle new problems, as well as recording such new problems and their associated characteristics, quickly and efficiently. Further in this regard, keyword weighting can be employed (based either on historical experience or expected importance of given keywords), in order to further improve the efficacy of the actions ultimately recommended.

Additionally, beyond preprocessing to identify keywords, a given problem's description is classified into an problem type, a classification which can be, for example, determined by a machine learning model. Based on historical data, the classification model can comprehend a number of problem types, which can be used to inform the business rules applied later in the process. As will also be appreciated in light of the present disclosure, the processing performed by data preprocessor 352 and natural language processor 354 can, in fact, be performed in an iterative fashion, until prepared data 350 reaches an acceptable level of accuracy and conciseness, such that prepared data 350 is in condition for use by other components of dynamic resolution architecture 300.

Certain aspects of data processing and analytics systems 304 also include the provision of data analytics functionality. In certain embodiments, examples of such functionality is the analysis performed by a resolution analysis unit 356 and one or more sub-intelligence engines 358. Resolution analysis unit 356 can analyze available information in order to identify historically successful resolutions using techniques such as identifying reasons for repeated contacts and/or the identification of multiple situations in which a problem resulted from a given cause. Further, resolution analysis unit 356 can make determinations as to commodity pairs, diagnostics compliance, risk predictions (e.g., as for the risk of failure), and intent/persona identification (e.g., as to the customer in question). Sub-intelligence engines 358 can be created and subsequently integrated to allow for the processing of repair information, information from field service, and/or voice transcripts. Sub-intelligence engines 358 can be implemented as a type of enterprise information management that combines business rule management, predictive analytics, and prescriptive analytics to form a unified information-access platform that provides real-time intelligence through search technologies, dashboards, and/or existing business infrastructure. An intelligence engine such as those of sub-intelligence engines 358 are created as part of data processing and analytics systems 304 as process- and/or business-problem-specific solutions, and so results in application- and/or function-specific solutions.

Information provided by problem information sources 302, once processed by data processing and analytics systems 304, are then presented as certain ones of system inputs 306. As will be appreciated in light of the present disclosure, certain embodiments of dynamic resolution architecture 300 take as system inputs 306 outputs from data processing and analytics systems 304 (e.g., prepared data 350), as well as, potentially, information from one or more external information sources 360 and feedback 334 from outcome processing unit 330 (designated in FIG. 3A by connector “B”). Such information can be stored in system inputs 306, for example, as contact information 370 (e.g., information regarding a customer), field service dispatch information 372 (e.g., information regarding the dispatches of field service, including personnel and/or parts), parts information 374, error code information 376, and existing problem information 377, among other forms of information.

System inputs 306 are presented to machine learning systems 310 and business rules processing unit 315, as well as to control logic 320, via connector “A”. Machine learning systems 310 analyze system inputs 306, and present the results of its analysis to control logic 320, such that control logic 320 is able to update action information of the actions being performed as part of the given action flow. Machine learning systems 310 can also provide the results of such analysis to business rules processing unit 315, and in so doing, facilitate the updating of the business rules information processed by business rules processing unit 315. Business rule information (not shown in FIG. 3B) used by business rules processing unit 315 can include rules that address a number of situations. For example, the business rule information can include business rules that result in a preference for lower cost resolutions (e.g., soft actions determined using an online, self-service web site), as opposed to higher cost resolutions (e.g., a service dispatch initiated by a customer service representative). As noted, such business rule information can also be updated with respect to problem types during the preprocessing of problem information and identification/selection of actions.

Control logic 320, having received inputs from machine learning systems 310 and business rules processing unit 315, receives system inputs 306 and determines the next action of the action flow to be performed (presenting such next action as, for example, recommended next action 322. In the embodiment depicted in FIG. 3B, recommended next action 322 represents recommended action next action information 325, which identifies, potentially, one or more potential next actions 380. Potential next actions 380, in turn, can include, for example, one or more of a guided solution 382 (e.g., information regarding instructions to begin a guided path in in online knowledgebase), a service dispatch 384 (e.g., one or more instructions with regard to starting a dispatch workflow with one or more parts potentially identified), a system assessment alert 385, a soft resolution 387, a diagnostic identification 388 (e.g., which could include instructions to perform one or more troubleshooting steps), and/or information regarding any existing issue 389, among other possible such resolutions. Recommended next action information 325 can identify, also potentially, one or more problems that were not resolved (represented in FIG. 3B by problem unresolved 390).

As noted, one or more of potential next actions 380 and/or information representing one or more unsolved problems, as well as, potentially, outcome information 327, or then input to outcome processing unit 330. Outcome processing unit 330 analyzes recommended next action information 325 and outcome information 327, and generates feedback 332 and feedback 334 therefrom. Feedback 332 is, as noted, fed back into machine learning systems 310, while feedback 334 is fed back to system inputs 306 via connector “B”, it being understood that such feedback provides for positive reinforcement of recommended actions resulting in the resolution of problems. Further, it will be appreciated that such positive reinforcement also tends to deemphasize unsuccessful resolutions, thereby protecting such systems from malicious actors (such faulty information not leading to successful resolutions, and so being deemphasized). Feedback 334 can, for example, be received at and maintained as existing problem information 377 and/or business rule information 378 (or modifications thereto).

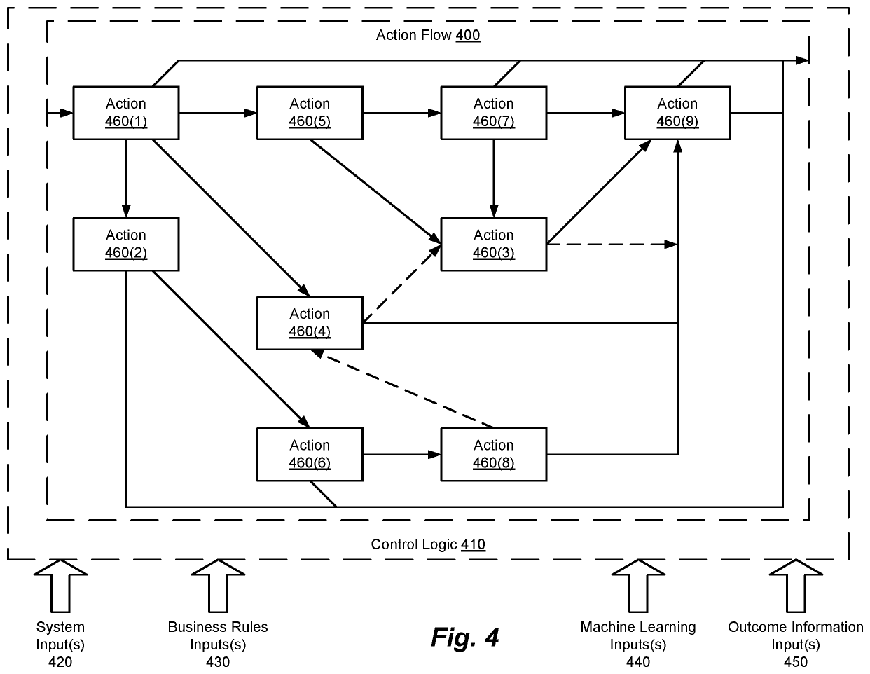

FIG. 4 is a simplified block diagram illustrating an example of an action flow, according to some embodiments. FIG. 4 thus depicts an action flow 400 implemented in control logic 410 (e.g., and as might be generated and/or updated by associated conditional logic and action selection logic such as that described earlier). In the manner noted earlier, control logic 410 receives one or more system inputs (depicted in FIG. 4 as system input(s) 420), one or more business rules inputs (depicted in FIG. 4 as business rules input(s) 430), one or more machine learning inputs (depicted in FIG. 4 as machine learning input(s) 440), one or more outcome information inputs (depicted in FIG. 4 as outcome information input(s) 450), and/or other such inputs, for example. In the example depicted in FIG. 4, action flow 400 is depicted as including a number of actions (depicted in FIG. 4 as actions 460(1)-(N), and referred to in the aggregate as actions 460).

As will be appreciated in light of the present disclosure, action flow 400 is simply one example of many possible such action flows, both in terms of the actions in action flow 400 and the transitions therebetween. Thus, for example, actions 460 may be identified from a larger set of such actions (potential ones of actions 460 being referred to herein as a steps pool (e.g., including one or more probing steps, troubleshooting steps, and diagnostic steps, for example), and/or one or more solutions (referred to herein as a solutions pool)). As will also be appreciated, the scenario depicted in FIG. 4 is one in which action flow 400 remains resident in control logic 410 (at least in a conceptual sense), such that the inputs received (system inputs 420, business rules inputs 430, machine learning inputs 440, and/or outcome information inputs 450, as well as the actual performance of the action(s) in question) result in the transitioning between various ones of actions 460. Thus, for example, the traversing of action flow 400 might begin with performing action 460(1). Depending on a result thereof, action flow 400 could transition to any one of action 460(2), 460(4), or 460(5), or could, in the alternative, result in a success that transitions out of action flow 400. As noted, such transitions are dependent upon the inputs two control logic 410, as well as the effects that such transitions may have on transitions within action flow 400. For example, results of action 460(1), 460(8), 460(5), or others of actions 460, in combination with the given criteria (i.e., the various inputs to control logic 410) can result in changes to the probabilities associated with any given transition, as well as the existence of both actions and/or transitions. In the scenario depicted in FIG. 4, new probabilities may be associated with the existing transitions (shown in solid lines) and/or generation of new transitions (shown in dotted lines). Further, it will be appreciated that, as between an action pool and a solution pool, the various probabilities of success associated with each may result in the selection of any one of the given actions or solutions, based, at least in part, on the conditional logic and business rules involved, and there ability to dynamically identify the next logical step to be taken, given the criteria identified. An example of such an action flow can be found, for example, in U.S. Pat. No. 8,533,661, entitled “System and method for automated on-demand creation of a customized software application,” filed Sep. 10, 2013, and having R. Nucci and M. Stewart as inventors, which is incorporated by reference herein.

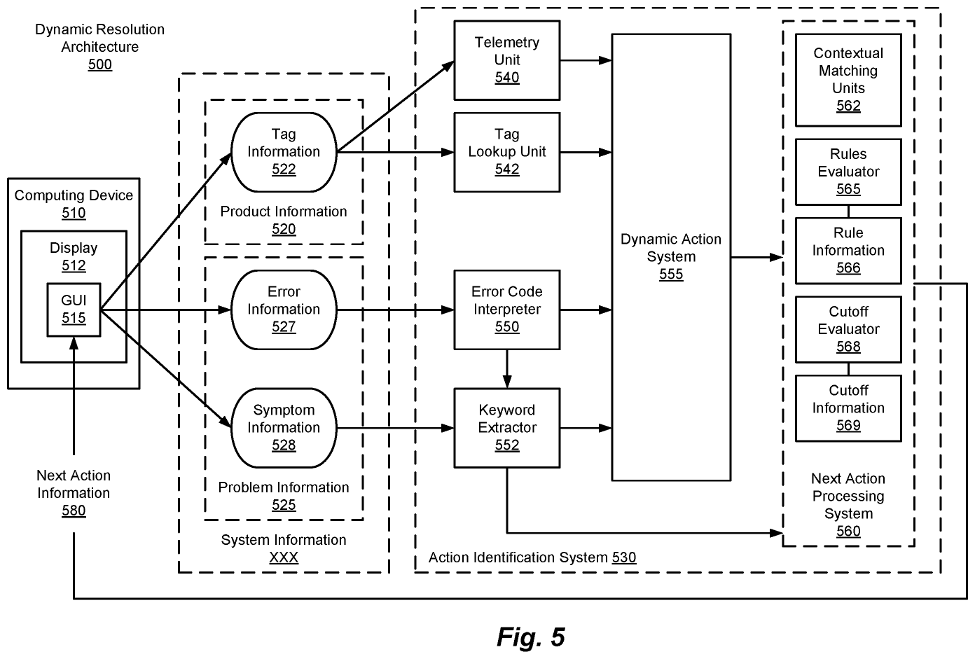

FIG. 5 is a simplified block diagram illustrating an example of a dynamic resolution architecture, according to some embodiments. FIG. 5 thus depicts a dynamic resolution architecture 500. Dynamic resolution architecture 500 includes a computing device 510 (having a display 512 capable of displaying a graphical user interface (GUI; or more simply, a user interface (UI); and depicted in FIG. 5 as a GUI 515)) that facilitates provision of inputs (e.g., product information 520 and problem information 525) to a action identification system 530. Action identification system 530 generates one or more actions that can be implemented to resolve a problem, and information regarding which is presented in GUI 515. In certain embodiments, product information 520 can include tag information 522, while in those or other embodiments, problem information 525 can include error information 527 and/or symptom information 528 (the provision of which may depend on the given problem(s) encountered by the user (e.g., customer)).

In certain embodiments, product information 520 (and, in particular, tag information 522) and problem information 525 (and, in particular, error information 527 and/or symptom information 528) are provided to action identification system 530 at inputs thereof. That being the case, action identification system 530 can include a telemetry unit 540 (e.g., such as “on-the-box” telemetry provided by hardware monitors, software daemons, or other such hardware or software module), a tag lookup unit 542, an error code interpreter 550 and a keyword extractor 552, such components receiving the aforementioned information. In particular, telemetry unit 540 gathers information regarding errors, failures, symptoms, and other events experienced by the given product, while tag lookup unit 542 provides information regarding the asset in question to the machine learning and action identification systems (described subsequently).

In operation, telemetry unit 540 and tag lookup unit 542 received tag information 522, while error code interpreter 550 receives error information 527 and keyword extractor 552 receives symptom information 528. Telemetry unit 540 and tag lookup unit 542, as well as error code interpreter 550 and keyword extractor 552 provide outputs to a dynamic action system 555, such as that described in connection with FIGS. 1 and 2. Error code interpreter 550 can also provide input to keyword extractor 552 in order to assist keyword extractor 552 in identifying keywords associated with the error information in question. Dynamic action system 555 then provides a proposed next action to next action processing system 560. Next action processing system 560, in turn, can include one or more contextual matching units 562, a rules evaluator 565 (which evaluates information received by next action processing system 560 using one or more rules maintain in rule information 566), and a cutoff evaluator 568 (which evaluates such inputs with respect to cutoff values maintained in cutoff information 569). The operation of components of next action processing system 560 are discussed subsequently.

As noted, a dynamic action system such as dynamic action system 555 can include a machine learning system, which can facilitate the identification, selection, and/or transition probabilities between the actions of the action flow being executed (and the inclusion pre exclusion of actions in/out of the given action flow). In certain embodiments, dynamic action system 555 can include one or more machine learning systems including a guided path (GP) model, a soft model, a hard model, and/or a cluster model. The operation of components of dynamic action system 555 are discussed subsequently. In such embodiments, information provided by telemetry unit 540, tag lookup unit 542, error code interpreter 550, and keyword extractor 552 is presented to such machine learning systems of dynamic action system 555, which can then, in concert with the business rule processing unit and control logic of dynamic action system 555, present next action processing system 560 with one or more potential next actions.

In certain embodiments, it is advantageous for such machine learning systems to employ logistic regression, with the various models just described. Logistic regression analysis lends itself to use in classification (either in a binary output, or multiple value output) of the kind contemplated by methods and systems such as those described herein. In the present scenario, logistic regression is useful for classifying potential actions for use in resolving problems, and providing a level of confidence in that regard.

Being a predictive analysis algorithm (and based on the concept of probability), logistic regression is a statistical model that can be used to provide for the classification of potential actions and predict the potential for success of such potential actions in addressing the problem at hand. In regression analysis, logistic regression estimates the parameters of a logistic model (a form of binary regression), using the Sigmoid function to map predictions to probabilities. Mathematically, a binary logistic model has a dependent variable with two possible values (e.g., in the present application, whether a given action will provide the desired resolution), which can be represented by an indicator variable (e.g., with its two possible values are labeled “0” and “1”). In such a logistic regression approach, the log-odds (the logarithm of the odds) for the value labeled “1” is a linear combination of one or more independent variables (“predictors”), such as the aforementioned machine learning analysis inputs; the independent variables can each be a binary variable (two classes, coded by an indicator variable) or a continuous variable (any real value). The corresponding probability of the value labeled “1” can vary between 0 (certainly the value “0”) and 1 (certainly the value “1”), hence the labeling; the function that converts log-odds to probability is the logistic function. However, it will be appreciated that various machine learning models, using different sigmoid functions (rather the logistic function) can also be used. It will be appreciated in light of present disclosure that a characteristic of the logistic model is that increasing one of the independent variables multiplicatively scales the odds of the given outcome at a constant rate, with each independent variable having its own parameter; for a binary dependent variable this generalizes the odds ratio.

In embodiments employing a binary logistic regression approach, the logical regression has two levels of the dependent variable; categorical outputs with more than two values can be modeled by multinomial logistic regression, and if the multiple categories are ordered, by ordinal logistic regression (e.g., the proportional odds ordinal logistic model). The various models described herein form the basis of classifiers for the various possible actions. Using the logistic regression approach as the basis for a classifier, can be effected, for instance, by choosing a cutoff value and classifying inputs with probability greater than the cutoff as one class, below the cutoff as the other, and in so doing, implement a binary classifier.

As noted, dynamic action system 555 can be implemented with a number of different machine learning models, which predict the probability of correspondingly different types of solutions (allowing such machine learning systems to follow a dynamically-guided path, which may include performing a soft solution or the dispatch of a hard solution). In each case, such machine learning models can take, at least in part inputs from the tag information and keywords established from the user input. The output of these models is a series of possible solutions and probabilities, which can be used to update or otherwise modify action information related to the actions specified in or added to the action flow in question. For such models, the probabilities can indicate if the given problem was solved by that type of solution in the past, how often that particular solution was selected in the past, and other such information. In so doing, such machine learning systems are able to dynamically alter the action flow in question, thereby allowing such systems to respond to existing and new scenarios in a more flexible and efficient manner than otherwise possible.

For the three aforementioned machine learning models, the logistic regression technique described earlier can be employed, with different historical data sets being used for each of the machine learning models employed. In one embodiment, each of the machine learning models uses historical information that includes product information such as a service tag and problem information such as keywords. For each input in such historical data, the machine learning model determines the correlation between that input any particular outcome. Once the correlations between the historical inputs are calculated, the machine learning model can use that information to determine the likelihood of a given outcome for a new set of inputs. The machine learning model can some these weighted inputs and uses the results to determine which of the available alternatives is the most likely to address the given scenario at the given point in the action flow at which the decision is to be made. The machine learning models' analysis of the machine learning input data produces information regarding possible likely solutions. For such machine learning model, data-driven thresholds can be used to define high, medium, and low confidence levels, for example, and so generate updates action information for the actions of the action flow.

As noted, the components of next action processing system 560 receive next action information from dynamic action system 555. As noted, rules evaluator 565 of next action processing system 560, using rule information 566, can affect the outputs of dynamic action system 555, in order to give effect to various business considerations that may further affect the desirability of a given one of the recommended actions generated by dynamic action system 555. In comparable fashion, as also described, cutoff evaluator 568, using cutoff information 569, can be used to affect classification of the outputs of dynamic action system 555 by allowing a cutoff value to be chosen and using that cutoff value to classify inputs (e.g., by classify inputs with a probability greater than the cutoff as one class, and below the cut off as another class, when logistic regression is used implement a binary classifier). Further still, contextual matching units 562 can be used to analyze information received from other sources (e.g., telemetry unit 540 and tag lookup unit 542), as well as the output of dynamic action system 555, in assisting with providing information in identifying preferred actions. Next action processing system 560, presents one or more recommended actions to a user in, for example, GUI 515, as next action information 580.

While not required, certain embodiments will provide various platforms and/or services to support the aforementioned functionalities and the deployment thereof in a cloud environment. Such an architecture can be referred to as, for example, a cloud-native application architecture, which provides for development by way of a platform that abstracts underlying infrastructure. In so doing, methods and systems such as those described herein are better able to focus on the creation and management of the services thus supported.

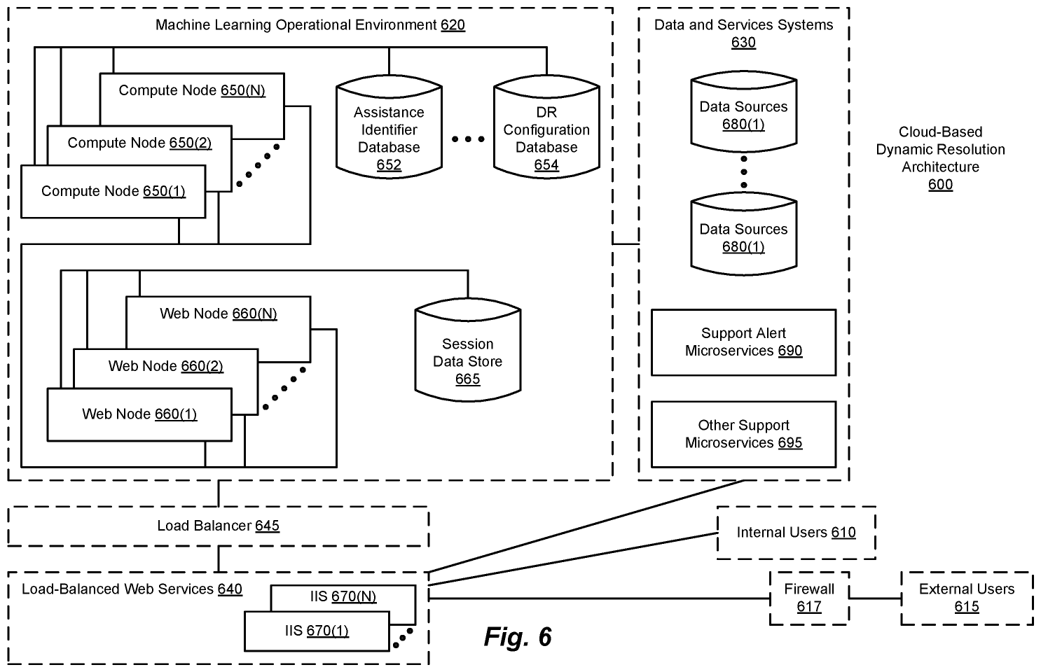

FIG. 6 is a simplified block diagram illustrating an example of a cloud-based dynamic resolution architecture employing such techniques, according to some embodiments. As will be appreciated in light of the present disclosure, a guided resolution architecture such as dynamic resolution architecture 600 can be implemented in a data center or other cloud-based computing environment. That being the case, a cloud-based guided resolution architecture 600 is depicted in FIG. 6. Cloud-based guided resolution architecture 600, in the embodiment depicted in FIG. 6, provides guided resolution functionalities such as that described herein to one or more internal users 610 and/or one or more external users 615 (e.g., as by a firewall 617). Components of cloud-based guided resolution architecture 600 depicted in FIG. 6 include a machine learning operational environment 620 that receives information from data and services systems 630, and makes available such functionality to internal users 610 and external users 615 by way of load-balanced web services 640 via a connection there to through a load balancer 645 (which provides for access to machine learning operational environment 620 by way of guided resolution engine entry, and can be implemented by, for example, one or more load-balancing appliances).

Machine learning operational environment 620 provides functionalities such as that provided via dynamic resolution architecture 600 through its support of various components. These components include some number of compute nodes (depicted in FIG. 6 as compute nodes 650(1)-(N), in the aggregate compute nodes 650) that access a number of databases, including an assistance identifier database 652 and a dynamic resolution configuration database 654. In turn, compute nodes 650 support functionality provided via a number of web nodes (depicted in FIG. 6 as web nodes 660(1)-(N), in the aggregate web nodes 660), which access a session data store 665. As will be appreciated, compute nodes 650 can be used to effect dynamic action system such as those described herein, while data sources 680 can be used to maintain the information supporting such dynamic action systems.

Internal users 610 and/or external users 615, as noted, access the functionalities provided by the components of machine learning operational environment 620 via load-balanced web services 640, which, in turn, access the components of machine learning operational environment 620 via load balancer 645. In support of such access, the functionality provided by load-balanced web services 640 is supported by a number of Internet information servers (IIS; depicted in FIG. 6 as IIS 670(1)-(N), and referred to in the aggregate as IIS 670).

In support of the functionalities provided by the components of machine learning operational environment 620, such components access the components of data and services systems 630. To that end, data and services systems 630 maintain a number of data sources (depicted in FIG. 6 as data sources 680(1)-(N), and referred to in the aggregate as data sources 680). Among the services provided by data and services systems 630 are telemetry microservices 690 (e.g., such as an “on-the-box” telemetry microservices, in the manner of the telemetry modules described earlier) and other support microservices 695.

### Example Processes for Dynamic Resolution Employing Machine Learning

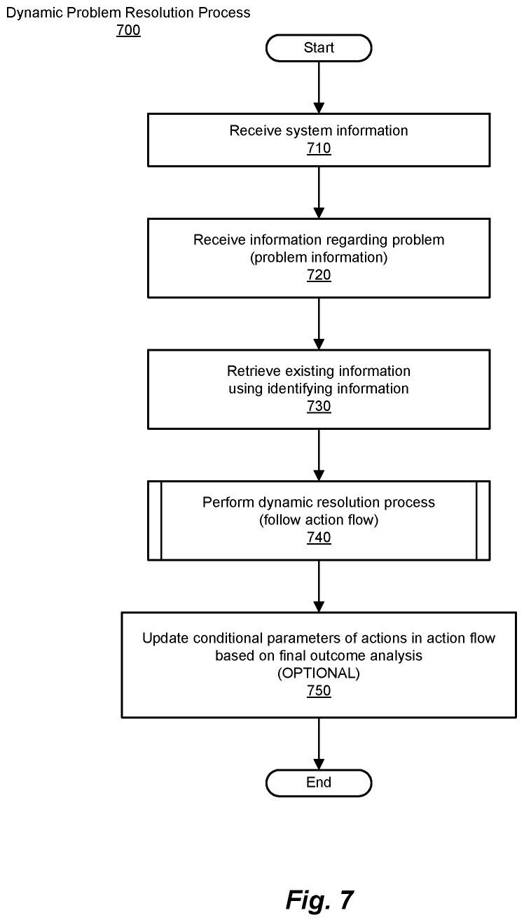

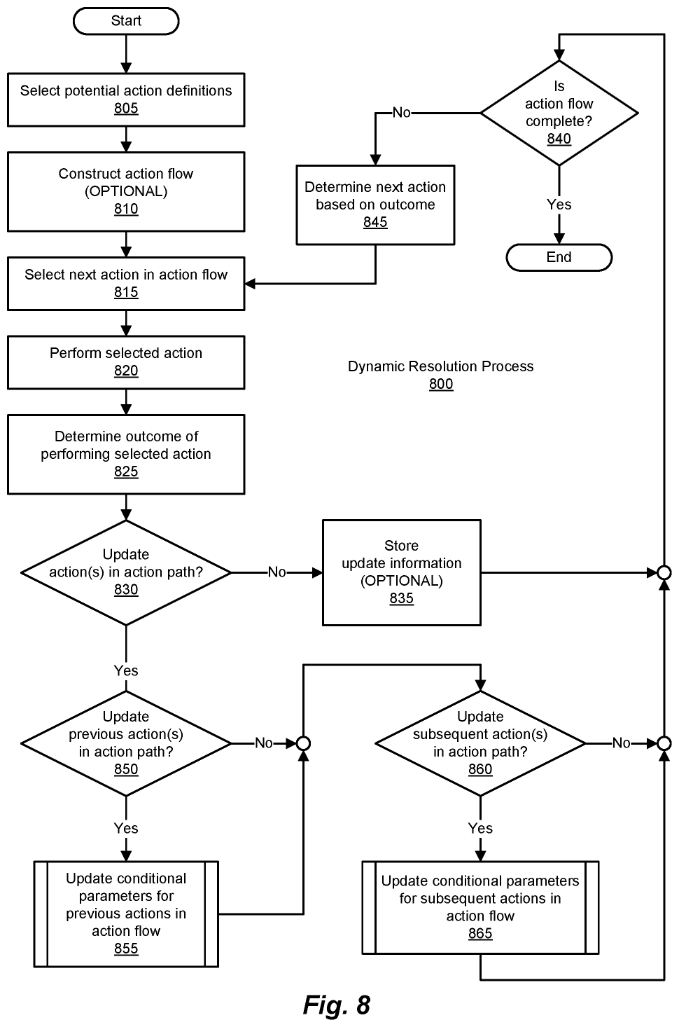

FIG. 7 is a simplified flow diagram illustrating an example of a problem resolution process, according to some embodiments. FIG. 7 thus depicts a dynamic problem resolution process 700. Dynamic problem resolution process 700 begins with receipt of system inputs such as those described earlier. The receipt of such system inputs can include the receipt of system information (information regarding the system encountering the problem in question) (710) and information regarding the problem in question (problem information) (720). At this juncture, existing information can be retrieved using identifying information received as part of the system information and/or problem information (730). Next, a dynamic resolution process is performed (e.g., as by following the actions of an applicable action flow) (740). A more detailed discussion of such a dynamic resolution process is provided in connection with the example process presented in FIG. 8, subsequently. In certain embodiments, once the dynamic resolution process (action flow) in question has completed, conditional parameters (e.g., action information) for the actions in the action flow can be updated based on a final outcome analysis (750). Such may be the case where the action flow in question is followed to its conclusion, prior to action information for its actions being updated. In such scenarios, update information for the conditional parameters (e.g., action information) in question is maintained until the action flow is complete, at which time the accumulated update information is used to update the affected action information. (As will be appreciated, in the alternative or in combination therewith, such update information can be applied during the process of executing the given action flow, allowing updating of the action flow in a dynamic fashion, as is discussed subsequently herein.) Dynamic problem resolution process 700 then concludes.

FIG. 8 is a simplified flow diagram illustrating an example of a dynamic resolution process, according to some embodiments. FIG. 8 thus depicts a dynamic resolution process 800. Dynamic resolution process 800 in the example depicted in FIG. 8, begins with the selection of the action definitions for one or more potential actions to be taken as part of the action flow in question (805). As will be appreciated, the selection of such actions is based on the criteria of the given situation, in the manner noted previously herein. Next, optionally, the action flow in question can be constructed (810). Such construction can include the identification of one or more steps to form a steps pool (e.g., including one or more probing steps, troubleshooting steps, and diagnostic steps, for example), and/or one or more solutions in order to form a solutions pool. Once the action flow in question has been constructed (or, if created by an author, retrieved), the next action in the action flow is selected (815). As will be appreciated, this step includes the selection of the first action in the action flow.

Next, the selected action is performed (820). Performance of the selected action can include execution of software such as diagnostic or troubleshooting software, performing one or more manual actions in order to attempt to re-create a problem, or the performance of other such actions. The outcome of performing the selected action is then determined (825). As noted elsewhere herein, the outcome of an action can include completion of the action flow (e.g., as by successful resolution of the problem at hand), the potential transition to another action, the gathering of additional information, or other such outcomes. Moreover, information regarding the outcome of the selected action's performance can include the receipt of information from a user, in addition to/as an alternative to receipt of data provided in an automated fashion.

A determination is then made as to whether actions in the action path are to be updated concurrently with execution of the actions in the action path (830). In the case in which actions in the action path are to be updated upon completion of the action path, dynamic resolution process 800 proceeds to the (optional) storage of the update information resulting from the aforementioned outcome (835). Such update information can be stored as a table in a database (e.g., with rows thereof reflecting changes and probabilities, organized by columns representing the affected actions). Dynamic resolution process 800 then proceeds to a determination as to whether the action flow in question is complete (840). If the action flow in question has not yet completed, dynamic resolution process 800 makes a determination as to the next action in the action flow to be taken, based on information regarding the outcome of the prior action (845). Alternatively, if the action flow in question is now complete (840), dynamic resolution process 800 concludes.

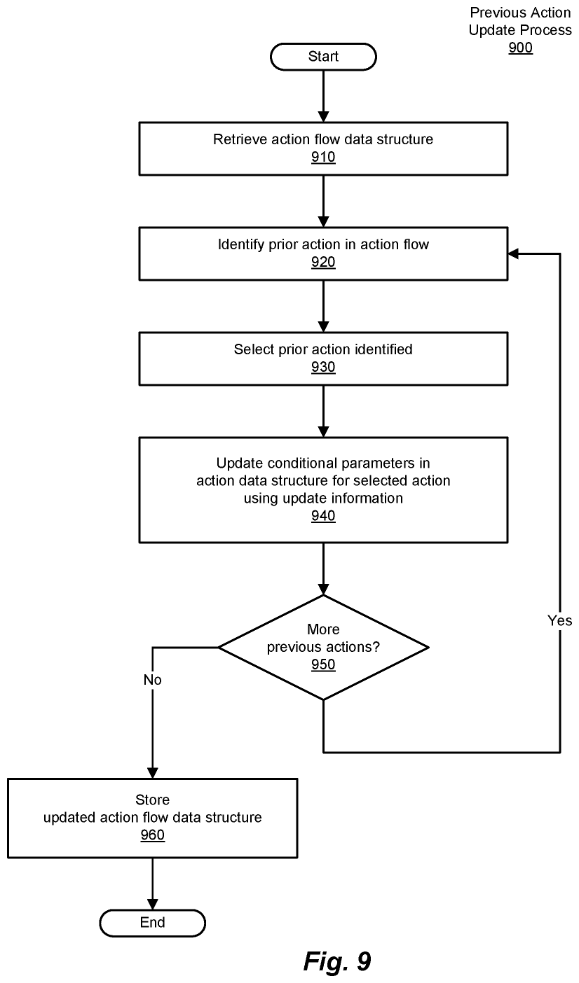

In the case in which actions in the action path are to be updated concurrently with the traversal of the action flow in question (830), dynamic resolution process 800 proceeds with making a determination as to whether actions previous to the present action in the action path should be updated (850). As will be appreciated, this determination also involves determining whether any previous actions exist (e.g., as in the case of the present action being the first action in the action flow). In the case in which one or more actions occur prior to the present action in the action flow, those previous actions' conditional parameters are updated using update information based on (or including) information regarding the outcome of the present action (855). A more detailed discussion of such a previous action update process is provided in connection with the example process presented in FIG. 9, subsequently.

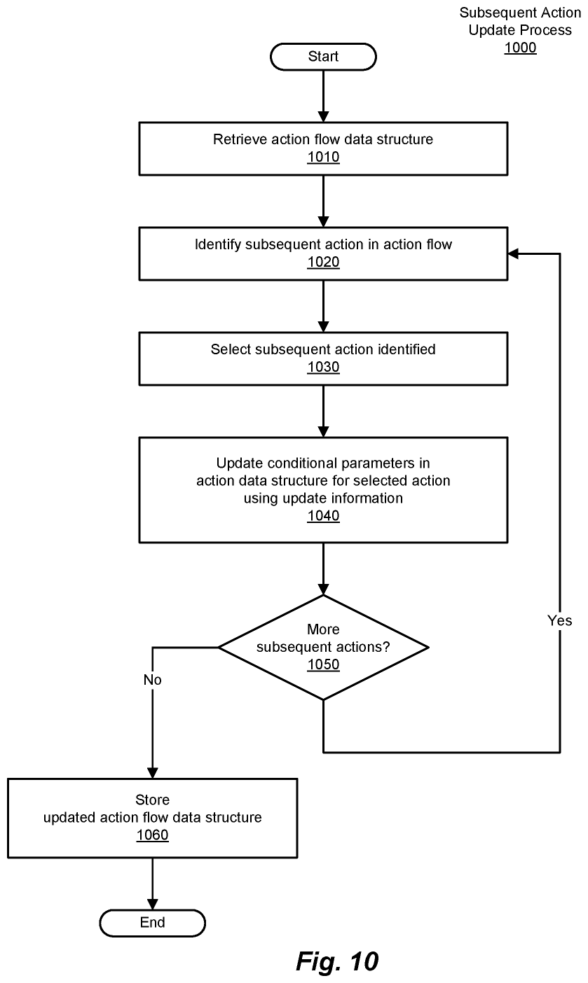

Once any previous actions have been so updated (or no such previous actions are to be updated), dynamic resolution process 800 proceeds to a determination as to whether actions subsequent to the present action in the action path should be updated (860). Here again, this determination also involves determining whether any actions subsequent to the present action exist (e.g., as in the case of the present action being the last action in the action flow). In the case in which one or more actions occur subsequent to the present action in the action flow, those subsequent actions' conditional parameters are updated using update information based on (or including) information regarding the outcome of the present action (865). As will be appreciated, the updating of actions subsequent to the present action in the action flow represents the modification of actions not yet taken. That being the case, embodiments such as those described herein not only avoid inflexibility in the action flows thus implemented, but also allows such action flows to change which actions (if any) will be taken in the future, when executing the given action flow. A more detailed discussion of such a subsequent action update process is provided in connection with the example process presented in FIG. 10, subsequently.

Once any subsequent actions have been so updated (or no such subsequent actions are to be updated), dynamic resolution process 800 proceeds to the determination as to whether the action flow in question is complete (840). If the action flow in question has not yet completed, dynamic resolution process 800 makes a determination as to the next action in the action flow to be taken, based on information regarding the outcome of the prior action (845). Alternatively, if the action flow in question is now complete (840), dynamic resolution process 800 concludes.

FIG. 9 is a simplified flow diagram illustrating an example of a previous action update process, according to some embodiments. FIG. 9 thus depicts a previous action update process 900. Previous action update process 900, as depicted in the example of FIG. 9, begins with the retrieval of the action flow data structure for the action flow in question (the data structure representing the action flow in question) (910). To this end, while previous action update process 900 is shown as operating on an action flow data structure, it will be appreciated that the retrieval and storage described in connection therewith can be performed on the action information of each action in the action flow individually. Next, the prior action in the action flow is identified (920). As will be appreciated, such prior action will be either with respect to the present action or the prior action just processed. The prior action identified is then selected for updating, if update information for the selected prior action exists (or such update information indicates that such updating should be performed). Assuming such updating is to be performed, the affected conditional parameters and/or other action information in the action data structure for the selected action are updated using the applicable update information (940).

A determination is then made as to whether further previous actions remain to be updated (950). In response to further previous actions remaining to be updated, previous action update process 900 loops to the identification of the next prior action in the action flow (920), and previous action update process 900 proceeds with processing any remaining prior actions in the action path. Alternatively, if no further previous actions remain to be updated, previous action update process 900 proceeds with storing the (now) updated action flow data structure (960). Previous action update process 900 then concludes.

FIG. 10 is a simplified flow diagram illustrating an example of a subsequent action update process, according to some embodiments. FIG. 10 thus depicts a subsequent action update process 1000. Subsequent action update process 1000, as depicted in the example of FIG. 10, begins with the retrieval of the action flow data structure for the action flow in question (the data structure representing the action flow in question) (910). To this end, while subsequent action update process 1000 is shown as operating on an action flow data structure, it will be appreciated that the retrieval and storage described in connection therewith can be performed on the action information of each action in the action flow individually. Next, the prior action in the action flow is identified (920). As will be appreciated, such prior action will be either with respect to the present action or the prior action just processed. The prior action identified is then selected for updating, if update information for the selected prior action exists (or such update information indicates that such updating should be performed). Assuming such updating is to be performed, the affected conditional parameters and/or other action information in the action data structure for the selected action are updated using the applicable update information (940).

A determination is then made as to whether further subsequent actions remain to be updated (950). In response to further subsequent actions remaining to be updated, subsequent action update process 1000 loops to the identification of the next prior action in the action flow (920), and subsequent action update process 1000 proceeds with processing any remaining prior actions in the action path. Alternatively, if no further subsequent actions remain to be updated, subsequent action update process 1000 proceeds with storing the (now) updated action flow data structure (960). Subsequent action update process 1000 then concludes.

### Example Computing and Network Environments

As shown above, the systems described herein can be implemented using a variety of computer systems and networks. The following illustrates an example configuration of a computing device such as those described herein. The computing device may include one or more processors, a random access memory (RAM), communication interfaces, a display device, other input/output (I/O) devices (e.g., keyboard, trackball, and the like), and one or more mass storage devices (e.g., optical drive (e.g., CD, DVD, or Blu-ray), disk drive, solid state disk drive, non-volatile memory express (NVME) drive, or the like), configured to communicate with each other, such as via one or more system buses or other suitable connections. While a single system bus 514 is illustrated for ease of understanding, it should be understood that the system buses 514 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

Such CPUs are hardware devices that may include a single processing unit or a number of processing units, all of which may include single or multiple computing units or multiple cores. Such a CPU may include a graphics processing unit (GPU) that is integrated into the CPU or the GPU may be a separate processor device. The CPU may be implemented as one or more microprocessors, microcomputers, microcontrollers, digital signal processors, central processing units, graphics processing units, state machines, logic circuitries, and/or any devices that manipulate signals based on operational instructions. Among other capabilities, the CPU may be configured to fetch and execute computer-readable instructions stored in a memory, mass storage device, or other computer-readable storage media.

Memory and mass storage devices are examples of computer storage media (e.g., memory storage devices) for storing instructions that can be executed by the processors 502 to perform the various functions described herein. For example, memory can include both volatile memory and non-volatile memory (e.g., RAM, ROM, or the like) devices. Further, mass storage devices may include hard disk drives, solid-state drives, removable media, including external and removable drives, memory cards, flash memory, floppy disks, optical disks (e.g., CD, DVD, Blu-ray), a storage array, a network attached storage, a storage area network, or the like. Both memory and mass storage devices may be collectively referred to as memory or computer storage media herein and may be any type of non-transitory media capable of storing computer-readable, processor-executable program instructions as computer program code that can be executed by the processors as a particular machine configured for carrying out the operations and functions described in the implementations herein.

The computing device may include one or more communication interfaces for exchanging data via a network. The communication interfaces can facilitate communications within a wide variety of networks and protocol types, including wired networks (e.g., Ethernet, DOCSIS, DSL, Fiber, USB, etc.) and wireless networks (e.g., WLAN, GSM, CDMA, 802.11, Bluetooth, Wireless USB, ZigBee, cellular, satellite, etc.), the Internet and the like. Communication interfaces can also provide communication with external storage, such as a storage array, network attached storage, storage area network, cloud storage, or the like.

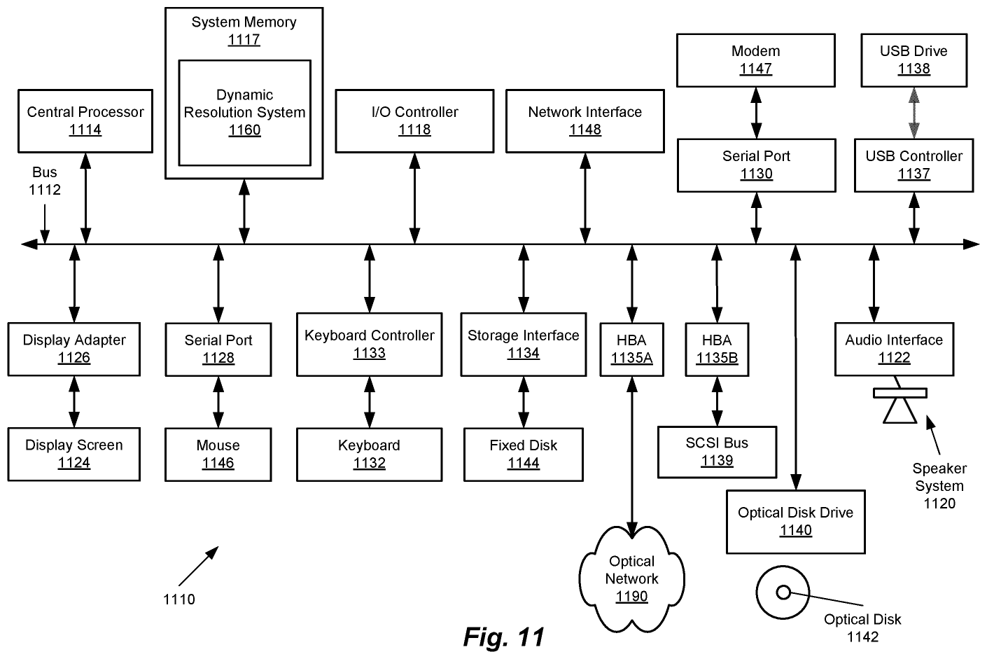

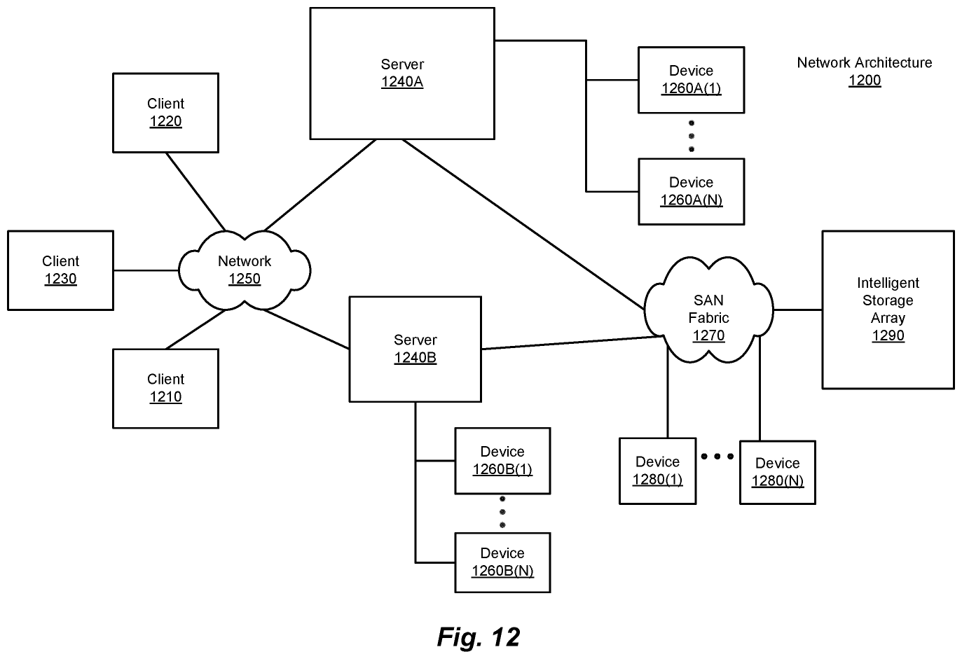

The display device may be used for displaying content (e.g., information and images) to users. Other I/O devices may be devices that receive various inputs from a user and provide various outputs to the user, and may include a keyboard, a touchpad, a mouse, a printer, audio input/output devices, and so forth. The computer storage media, such as memory 504 and mass storage devices, may be used to store software and data, such as, for example, an operating system, one or more drivers (e.g., including a video driver for a display such as display 180), one or more applications, and data. Examples of such computing and network environments are described below with reference to FIGS. 11 and 12.

FIG. 11 depicts a block diagram of a computer system 1110 suitable for implementing aspects of the systems described herein, and so can be viewed as an example of a computing device supporting a microservice production management server, for example. Computer system 1110 includes a bus 1112 which interconnects major subsystems of computer system 1110, such as a central processor 1114, a system memory 1117 (typically RAM, but which may also include ROM, flash RAM, or the like), an input/output controller 1118, an external audio device, such as a speaker system 1120 via an audio output interface 1122, an external device, such as a display screen 1124 via display adapter 1126 (and so capable of presenting microservice dependency visualization data such as microservice dependency visualization data 225 as visualization 1000 in FIG. 10), serial ports 1128 and 1130, a keyboard 1132 (interfaced with a keyboard controller 1133), a storage interface 1134, a USB controller 1137 operative to receive a USB drive 1138, a host bus adapter (HBA) interface card 1135A operative to connect with a optical network 1190, a host bus adapter (HBA) interface card 1135B operative to connect to a SCSI bus 1139, and an optical disk drive 1140 operative to receive an optical disk 1142. Also included are a mouse 1146 (or other point-and-click device, coupled to bus 1112 via serial port 1128), a modem 1147 (coupled to bus 1112 via serial port 1130), and a network interface 1148 (coupled directly to bus 1112).

Bus 1112 allows data communication between central processor 1114 and system memory 1117, which may include read-only memory (ROM) or flash memory (neither shown), and random access memory (RAM) (not shown), as previously noted. RAM is generally the main memory into which the operating system and application programs are loaded. The ROM or flash memory can contain, among other code, the Basic Input-Output System (BIOS) which controls basic hardware operation such as the interaction with peripheral components. Applications resident with computer system 1110 are generally stored on and accessed from a computer-readable storage medium, such as a hard disk drive (e.g., fixed disk 1144), an optical drive (e.g., optical drive 1140), a universal serial bus (USB) controller 1137, or other computer-readable storage medium.

Storage interface 1134, as with the other storage interfaces of computer system 1110, can connect to a standard computer-readable medium for storage and/or retrieval of information, such as a fixed disk drive 1144. Fixed disk drive 1144 may be a part of computer system 1110 or may be separate and accessed through other interface systems. Modem 1147 may provide a direct connection to a remote server via a telephone link or to the Internet via an internet service provider (ISP). Network interface 1148 may provide a direct connection to a remote server via a direct network link to the Internet via a POP (point of presence). Network interface 1148 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 11 need not be present to practice the systems described herein. The devices and subsystems can be interconnected in different ways from that shown in FIG. 11. The operation of a computer system such as that shown in FIG. 11 is readily known in the art and is not discussed in detail in this application. Code to implement portions of the systems described herein can be stored in computer-readable storage media such as one or more of system memory 1117, fixed disk 1144, optical disk 1142, or floppy disk 1138. The operating system provided on computer system 1110 may be WINDOWS, UNIX, LINUX, IOS, or other operating system. To this end, system memory 1117 is depicted in FIG. 11 as executing a dynamic resolution system 1160, in the manner of dynamic resolution systems such as those discussed previously herein, for example.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 12 is a block diagram depicting a network architecture 1200 in which client systems 1210, 1220 and 1230, as well as storage servers 1240A and 1240B (any of which can be implemented using computer system 1210), are coupled to a network 1250. Storage server 1240A is further depicted as having storage devices 1260A(1)-(N) directly attached, and storage server 1240B is depicted with storage devices 1260B(1)-(N) directly attached. Storage servers 1240A and 1240B are also connected to a SAN fabric 1270, although connection to a storage area network is not required for operation. SAN fabric 1270 supports access to storage devices 1280(1)-(N) by storage servers 1240A and 1240B, and so by client systems 1210, 1220 and 1230 via network 1250. An intelligent storage array 1290 is also shown as an example of a specific storage device accessible via SAN fabric 1270.

With reference to computer system 1110, modem 1147, network interface 1148 or some other method can be used to provide connectivity from each of client computer systems 1210, 1220 and 1230 to network 1250. Client systems 1210, 1220 and 1230 are able to access information on storage server 1240A or 1240B using, for example, a web browser or other client software (not shown). Such a client allows client systems 1210, 1220 and 1230 to access data hosted by storage server 1240A or 1240B or one of storage devices 1260A(1)-(N), 1260B(1)-(N), 1280(1)-(N) or intelligent storage array 1290. FIG. 12 depicts the use of a network such as the Internet for exchanging data, but the systems described herein are not limited to the Internet or any particular network-based environment.

### Other Embodiments

The example systems and computing devices described herein are well adapted to attain the advantages mentioned as well as others inherent therein. While such systems have been depicted, described, and are defined by reference to particular descriptions, such references do not imply a limitation on the claims, and no such limitation is to be inferred. The systems described herein are capable of considerable modification, alteration, and equivalents in form and function, as will occur to those ordinarily skilled in the pertinent arts in considering the present disclosure. The depicted and described embodiments are examples only, and are in no way exhaustive of the scope of the claims.

Such example systems and computing devices are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

The foregoing thus describes embodiments including components contained within other components (e.g., the various elements shown as components of computer system 1210). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation. As such, the various embodiments of the systems described herein via the use of block diagrams, flowcharts, and examples. It will be understood by those within the art that each block diagram component, flowchart step, operation and/or component illustrated by the use of examples can be implemented (individually and/or collectively) by a wide range of hardware, software, firmware, or any combination thereof.

The systems described herein have been described in the context of fully functional computer systems; however, those skilled in the art will appreciate that the systems described herein are capable of being distributed as a program product in a variety of forms, and that the systems described herein apply equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

In light of the foregoing, it will be appreciated that the foregoing descriptions are intended to be illustrative and should not be taken to be limiting. As will be appreciated in light of the present disclosure, other embodiments are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the claims. Variations and modifications of the embodiments disclosed herein can be made based on the description set forth herein, without departing from the scope of the claims, giving full cognizance to equivalents thereto in all respects.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
receiving outcome information at a machine learning system, wherein
the outcome information is associated with an action of an action flow, and
the action flow comprises a plurality of actions;
generating update information, wherein
the update information is generated by the machine learning system based, at least in part, on the outcome information; and
updating action information of the action, wherein
the action information is updated based, at least in part, on the update information.

2. The method of claim 1, further comprising:
identifying one or more actions of a plurality of actions; and
generating the action flow.

3. The method of claim 1, further comprising:
receiving product information at a dynamic resolution system, wherein
the product information describes one or more characteristics of a product; and
receiving problem information at the dynamic resolution system, wherein
the problem information describes one or more characteristics of a problem encountered with the product.

4. The method of claim 3, further comprising:
performing machine learning analysis of the problem information and the product information, wherein
the machine learning analysis produces one or more outputs,
the machine learning analysis is performed by the machine learning system, and
the machine learning analysis is performed using one or more machine learning models.

5. The method of claim 4, wherein
the one or more machine learning models comprise at least one of
a guided path model,
a soft model,
a hard model, or
a cluster model.

6. The method of claim 3, wherein
the problem information comprises at least one of
error information regarding an error experienced in operation of the product, or
symptom information regarding a symptom exhibited by the product in the operation of the product.

7. The method of claim 3, further comprising:
retrieving one or more system attributes for a product identified by the product information, and
retrieving a support history for the product.

8. The method of claim 1, further comprising:
performing an outcome analysis, wherein
the outcome analysis is based, at least in part, on information produced by executing the action,
the machine learning analysis is performed by one or more machine learning systems of the resolution identification system, and
a result of the outcome analysis is fed back to the machine learning system.

9. The method of claim 8, further comprising:
updating other action information of another action of the plurality of actions, wherein
the other action information is updated based, at least in part, on the result of the outcome analysis.

10. The method of claim 8, further comprising:
applying a business rule to the result of the outcome analysis, prior to the updating the action information of the action.

11. A non-transitory computer-readable storage medium comprising program instructions, which, when executed by one or more processors of a computing system, perform a method comprising:
receiving outcome information at a machine learning system, wherein
the outcome information is associated with an action of an action flow, and
the action flow comprises a plurality of actions;
generating update information, wherein
the update information is generated by the machine learning system based, at least in part, on the outcome information; and
updating action information of the action, wherein
the action information is updated based, at least in part, on the update information.

12. The non-transitory computer-readable storage medium of claim 11, wherein the method further comprises:
receiving product information at a dynamic resolution system, wherein
the product information describes one or more characteristics of a product; and
receiving problem information at the dynamic resolution system, wherein
the problem information describes one or more characteristics of a problem encountered with the product.

13. The non-transitory computer-readable storage medium of claim 12, wherein the method further comprises:
performing machine learning analysis of the problem information and the product information, wherein
the machine learning analysis produces one or more outputs,
the machine learning analysis is performed by the machine learning system, and
the machine learning analysis is performed using one or more machine learning models.

14. The non-transitory computer-readable storage medium of claim 12, wherein the method further comprises:
retrieving one or more system attributes for a product identified by the product information, and
retrieving a support history for the product.

15. The non-transitory computer-readable storage medium of claim 11, wherein the method further comprises:
performing an outcome analysis, wherein
the outcome analysis is based, at least in part, on information produced by executing the action,
the machine learning analysis is performed by one or more machine learning systems of the resolution identification system, and
a result of the outcome analysis is fed back to the machine learning system.

16. The non-transitory computer-readable storage medium of claim 15, wherein the method further comprises:
updating other action information of another action of the plurality of actions, wherein
the other action information is updated based, at least in part, on the result of the outcome analysis.

17. A system comprising:
one or more processors; and
a computer-readable storage medium coupled to the one or more processors, comprising
program instructions, which, when executed by the one or more processors,
perform a method comprising
receiving outcome information at a machine learning system, wherein
the outcome information is associated with an action of an action flow, and
the action flow comprises a plurality of actions,
generating update information, wherein
the update information is generated by the machine learning system based, at least in part, on the outcome information, and
updating action information of the action, wherein
the action information is updated based, at least in part, on the update information.

18. The system of claim 17, wherein the method further comprises:
performing an outcome analysis, wherein
the outcome analysis is based, at least in part, on information produced by executing the action,
the machine learning analysis is performed by one or more machine learning systems of the resolution identification system, and
a result of the outcome analysis is fed back to the machine learning system.

19. The system of claim 18, wherein the method further comprises:
updating other action information of another action of the plurality of actions, wherein
the other action information is updated based, at least in part, on the result of the outcome analysis.

20. The non-transitory computer-readable storage medium of claim 11, wherein the method further comprises:
receiving product information at a dynamic resolution system, wherein
the product information describes one or more characteristics of a product;
receiving problem information at the dynamic resolution system, wherein
the problem information describes one or more characteristics of a problem encountered with the product;
retrieving one or more system attributes for a product identified by the product information;
retrieving a support history for the product; and
performing machine learning analysis of the problem information and the product information
